(19) United States
(12) Patent Application Publication
(10) Pub. No.: US 2026/0356585 A1
(43) Pub. Date: Nov. 12, 2026

(54) A DEVICE AND METHOD FOR INSERTING STORAGE CONTAINERS INTO AN AUTOMATED STORAGE AND RETRIEVAL SYSTEM

(71) Applicant: AutoStore Technology AS, Nedre Vats (NO)

(72) Inventors: Audun Sagen, Oslo (NO); Øystein Gjerdevik, Skjold (NO); Amund Skålerud, Etne (NO); Joakim Myrbakken, Skudeneshavn (NO)

(21) Appl. No.: 19/123,327

(22) PCT Filed: Oct. 26, 2023
(86) PCT No.: PCT/EP2023/079885

§ 371 Date: Apr. 22, 2025

(30) Foreign Application Priority Data
Oct. 28, 2022 (NO) 20221156

(51) Int. Cl. B65G 1/04; B65G 1/06

(52) U.S. Cl. CPC B65G 1/0471; B65G 1/0485; B65G 1/065; B65G 2203/0216; B65G 2203/044

(57) ABSTRACT

A device (614) for mass insertion of storage containers (106) into an automated storage and retrieval system (104) and a method thereof is disclosed. The container insertion device (614) is provided with a conveyor (603) for transporting storage containers (106), a container preparation area (602) provided with a label affixing device (604), an ID scanner (605), a dimension scanning device (606). The device is also provided with a platform (607) that extends into a storage column (105) of the automated storage and retrieval system (104) to allow insertion of storage containers (106).

### FIELD OF THE INVENTION

The present invention relates to an automated storage and retrieval system for storage and retrieval of containers, in particular to a device for mass insertion of storage containers automatically into the storage and retrieval system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a, 301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b, 301c, 401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a, 401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns are storage columns 105, i.e. columns 105 where storage containers 106 are stored in stacks 107. FIG. 5 shows the lowermost level of a number of storage columns, with containers 106 placed at the lowermost position, for example adjacent to the floor of the facility.

As can be seen in FIG. 5, a storage column 105 is defined by four upright members 102. Guide profiles 103 are arranged on the upright members 102 to retain the containers within the confines of the storage column 105 and to guide the container 106 as it is raised or lowered by a container handling vehicle. The guide profiles 103 are comprised of two faces 103a arranged at 90 degree and positioned to retain the corners of the container 106. As further shown in FIG. 5, the framework structure may be enclosed by walls 111, in this figure showing storage columns 105 adjacent to wall 111.

In addition to storage columns 105, there are columns in the framework that may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” 20 within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

Insertion of Storage Containers into the System

An automated storage and retrieval 1 system often comprises several thousand storage containers 106. When initially constructed at a location, these several thousands of storage containers must be inserted into the system én mass. Likewise, if an existing system is expanded, many additional containers will need to be inserted into the system in a large operation. As can be appreciated, such mass insertion of storage containers, alternately referred to as “bins”, is difficult and time consuming.

Currently, each of these storage containers is manually inserted through port columns 119, 120 of the automated storage and retrieval system, from which they are picked up by the container handling vehicles 201, 301 401 and transported to their storage locations within the framework structure. The storage containers are carried by personnel in bulk from a storage area meant for the purpose of storage of the containers and inserted manually one by one into the framework structure via the dedicated access stations. Before insertion, the storage containers need to be labelled, scanned and tested to ensure that the dimensions of the containers are within certain tolerances.

Since manual container insertion operation requires a substantial amount of time, the access station or stations being used for container/bin insertion will be occupied and cannot be used for their intended purpose.

Hence, there is a need for an automated insertion solution, that is less cumbersome for inserting storage containers and avoids occupying the access station such that access stations would be free to perform their regular operations.

### SUMMARY OF THE INVENTION

The invention relates to a device and method for automatically inserting storage containers into an automated storage and retrieval system.

In an aspect of the invention, the automated storage and retrieval system is provided with a lateral opening, door or cut-out in a wall enclosing the framework structure of the storage and retrieval system, at or near the floor of the facility in which the automatic storage and retrieval system is installed. The opening provides access to a storage column arranged at the periphery of the framework structure, adjacent to the wall. In the event no wall encloses the framework structure, there will be a plurality of storage columns exposed at the periphery of the framework structure.

The storage container insertion device of the invention (hereafter referred to as the “container insertion device” or “insertion device”) may be transported to this opening, for example by rolling on wheels, allowing containers to be inserted into the automated storage and retrieval system via the exposed storage column, rather than occupying a port column at an access station for the temporary purpose of container insertion. This allows container insertion to be performed while the automatic storage and retrieval system is in operation, without occupying an access station.

In an aspect of the invention, the insertion device comprises a conveyor for transporting containers to be inserted from a rear part of the device to a forward part of the device. As the container is transported along the conveyor, it encounters one or more automated container-preparation devices for performing tasks related to preparing a container for insertion into the system, for example one or more of a label attaching device, a scanner, a camera, and/or other devices to measure the dimensions of the container. In one aspect the container-preparation devices are mounted in or on a compartment having a through-going passage with an entry and an exit through which the conveyor transports the containers, however such devices could be suspended above or on the sides of the conveyor by a support or other means.

The insertion device is further provided with an exit platform that extends outwards from the device and is arranged to be inserted laterally into the storage column exposed by the opening in the wall. The lateral dimensions of the platform is essentially the same as the lateral dimensions of a storage container, allowing the container to rest on the platform inside the storage column. In use, a storage container will be transported by the conveyor through the insertion device, encounter the various automated container-preparation devices, be transported to rest on the exit platform inside the storage column, where the container will await retrieval by a container handling vehicle that lowers its gripping device into the storage column. As can be appreciated, the insertion operation thus will greatly mitigate interference with the through-put of the system which would occur if one or more of the few access stations were diverted from their ordinary function to the task of container insertion. Once the container insertion operation is completed, the device may be removed, and the storage column made available for the normal storage of containers.

As described above in the background section, the storage columns of prior art automated storage and retrieval systems are defined by four upright members. These upright members often comprise guide profiles that help retain the corners of the containers within the confines of the storage column. Such guide profiles would therefore prevent storage containers or the platform of the insertion device from being inserted laterally into the storage column. Therefore, another aspect of the invention provides means to insert the containers laterally into the storage column.

In one aspect, the means to laterally insert the storage container may be to provide lateral openings in the guide profiles of the two upright members adjacent the opening in the wall. For example, a portion of the faces of the guide profiles that lie between the opening in the wall and the storage column may be cut away in a height at least as high as the containers. The platform of the insertion device and the containers can thus be inserted into the storage column though this lateral opening in the guide profile. An alternative solution would be to provide a movable segment of the faces of the guide profiles that lie between the opening in the wall and the storage column, whereby the movable segment may be pushed aside allowing a container to be inserted laterally. Examples of such a movable segment include a slidable segment that may be slid up or down or a hinged segment that may be pushed in or pulled out. In one example, the moveable segment can comprise hinged segments that are spring loaded, such that when the platform of the insertion device is inserted into the storage column, the platform pushes the segments inward against the force of a spring allowing the platform and containers to enter the storage column laterally. When the platform is removed, the spring will snap the segments back into place, where they can resume their guide profile function.

A storage container to be inserted into the automated storage and retrieval system is carried by the conveyor which transfers the storage container towards a compartment of the device. At the compartment, various container-preparation devices prepare the container for insertion. For example, a labelling device affixes a label/identification tag to the storage container. The label is scanned by the scanner or otherwise recorded, and the information related to the container entered in the control system of the storage and retrieval system. A scanner or other device measures the dimensions of the containers to ensure that the container is in accordance with predefined size limits. The device may also comprise a camera to record images of the storage container.

Once the container has encountered the various container-preparation devices and has been confirmed ready to be inserted into the storage system, the storage container is passed by the conveyor to rest on the exit platform within the storage column.

A container handling vehicle is then instructed by the control system that the storage container is ready to be picked up from the storage column.

According to on e aspect, the invention concerns a container insertion device for inserting storage containers into an automated storage and retrieval system laterally through a storage column of the system, the device comprising:
a conveyor arranged for transporting storage containers from a rear part of the insertion device to a forward part of the container insertion device;
an exit platform or support extending from the forward part of the container insertion device, the platform or support arranged to receive and support containers to be inserted into the storage and retrieval system, wherein the platform or support is dimensioned to be laterally inserted into the storage column and thereby support a storage container within the storage column for retrieval by a container-handling vehicle of the system; and
one or more of a label affixing device for affixing an identification label to a container, an ID scanning device for scanning an identification label, and/or a dimension scanning device arranged to measure the physical dimensions of the container, the one or more of said devices being in electronic communication with a control system of the storage and retrieval system.

According to another aspect, the invention concerns an automated storage and retrieval system, comprising a framework structure forming a storage grid, the framework structure comprising:
a rail system arranged at an upper level of the framework structure, the rail system comprising a first set of parallel rails arranged in a horizontal plane (P) and extending in a first direction (X), and a second set of parallel rails arranged in the horizontal plane (P) and extending in a second direction (Y) which is orthogonal to the first direction (X), which first and second sets of rails form a grid pattern in the horizontal plane (P) comprising a plurality of adjacent grid cells, and the storage grid defining a plurality of columns for use as storage columns, each storage column being arranged to store a respective stack of storage containers, wherein the storage columns are located beneath the rail system and wherein each storage column is located vertically below a respective grid cell;
a plurality of container handling vehicles that operate on the rail system (108) for storing and retrieving storage containers to and from storage columns,
a control system configured for interacting with the system components and sending instructions to a plurality of container handling vehicles CHARACTERIZED IN THAT the automated storage and retrieval system, comprises:
an exposed storage column at the periphery of the framework structure of the automated storage and retrieval system, the exposed storage column having a lateral opening permitting lateral insertion of storage containers into the storage column; and
a device as described above arranged for inserting storage containers through the lateral opening into the storage columns for subsequent retrieval by container handling vehicles.

According to another aspect, the invention concerns a method for inserting storage containers into an automated storage and retrieval system, the method comprises the steps of:
exposing a storage column at the periphery of a framework structure of the automated storage and retrieval system,
providing a lateral opening in the storage column, the lateral opening dimensioned to permit the lateral insertion of storage containers into the storage column,
providing a container insertion device as described above,
inserting the platform of the insertion device through the lateral opening in the storage column such that the platform extends into the storage column;
placing storage containers, one after the other, on the conveyor at the rear part of container insertion device,
activating the conveyor and transporting the storage containers in sequence downstream through the device,
affixing an identification label to the storage containers,
communicating identification information contained in the labels to the control system,
measuring the physical dimensions of the storage containers using a a dimension scanning device, and comparing the dimensions with predefined measurement tolerances,
transporting the storage containers along the conveyor until a container rests upon the platform within the storage column; and
sending instructions to a container handling vehicle of the automated storage and retrieval system to pick up the storage container from the platform resting on the storage column,
transporting the subsequent containers, in sequence to the platform for retrieval by in container handling vehicles.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a storage column, showing upright members with guide profiles.

FIG. 6 is a perspective view of an automated storage and retrieval system with an opening in a lower part of a wall enclosing the framework structure, exposing a storage column.

FIG. 7 depicts an embodiment of a container insertion device rolled adjacent the opening in wall enclosing the framework structure from FIG. 6.

FIG. 8 is a perspective cut-away view of an embodiment of a container insertion device.

FIG. 9 illustrates a storage container being checked for dimensions and scanned by a scanner before insertion into the storage column of the automated storage and retrieval system.

FIG. 10 depicts a storage container resting on an exit platform of the device and positioned in a storage column.

FIG. 11 illustrates the storage container resting on the exit platform of the container insertion device within the storage column, awaiting to be picked up by a container handling vehicle of the storage system.

FIGS. 12A and 12 B—illustrate an empty storage column adjacent the opening in the wall from FIG. 6, showing different embodiments of an opening in the guide profiles permitting lateral insertion of a container into the storage column. FIG. 12A shows segments of faces of the guide profiles removed, while FIG. 12B show hinged segments of faces of the guide profiles.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

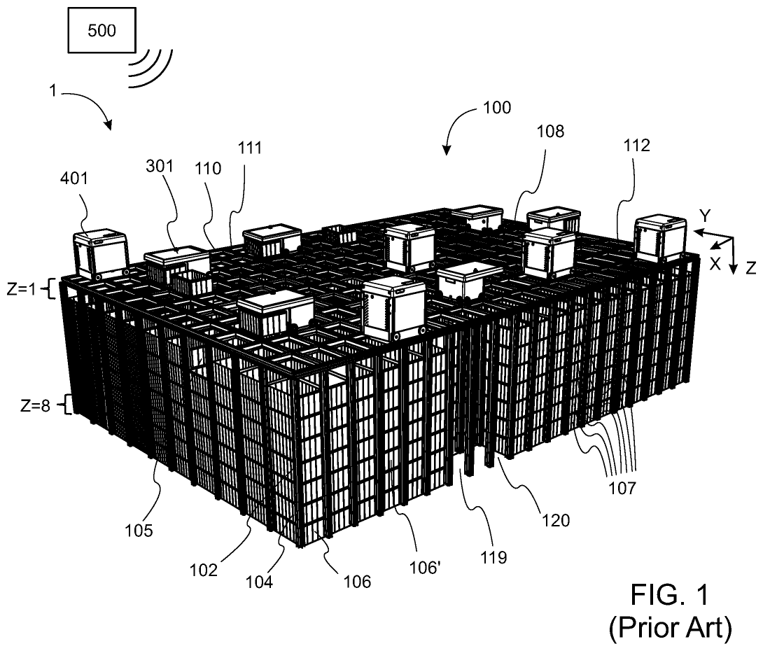

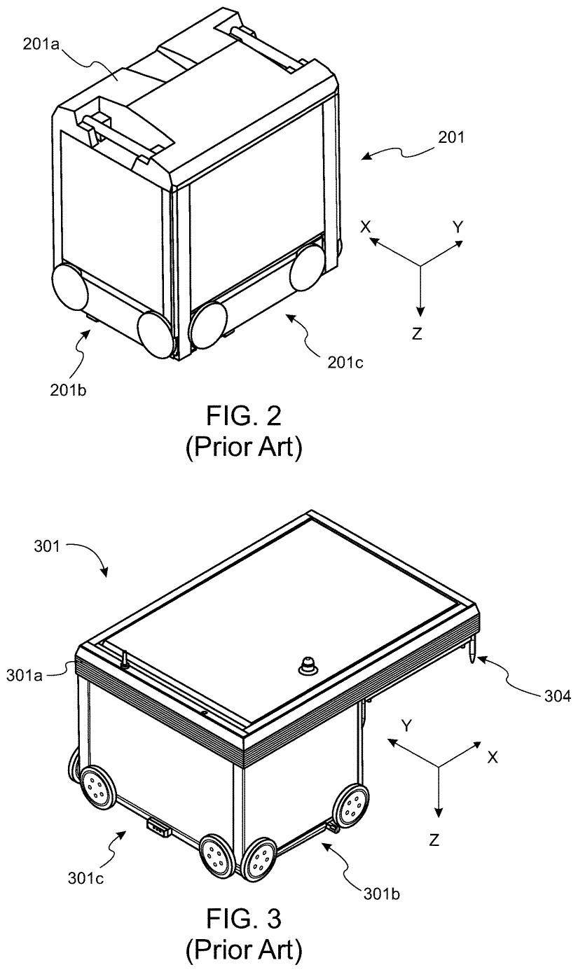

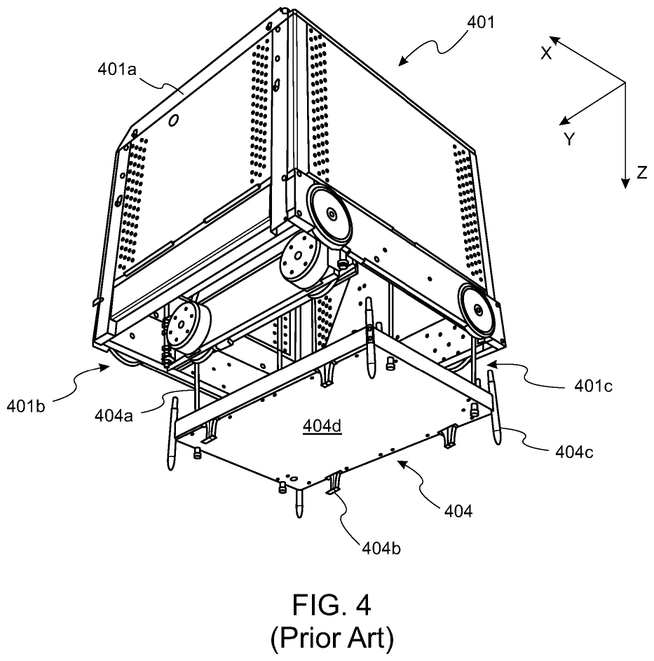

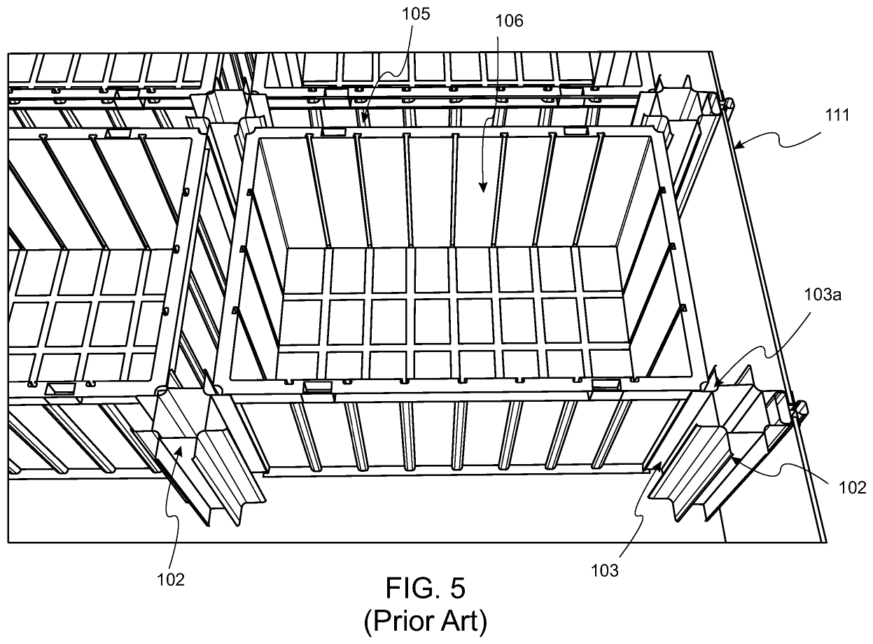

The framework structure 100 of the automated storage and retrieval system 1 is constructed in a similar manner to the prior art framework structure 100 described above in connection with FIGS. 1-5. That is, the framework structure 100, surrounded by a wall 111, comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

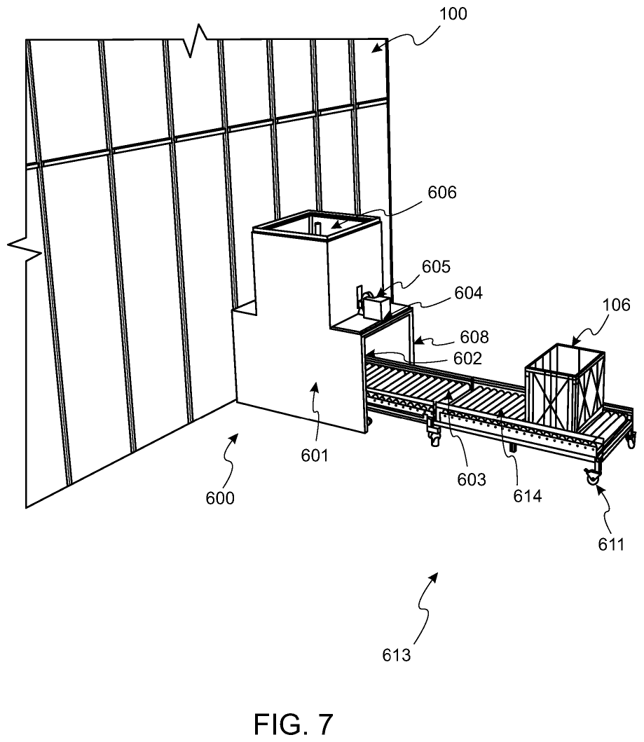

Aspects of a device and method for inserting containers into the automated storage and retrieval system according to the invention will now be discussed in more detail with reference to FIGS. 6-12.

Throughout the description, storage containers 106 may be alternately referred to as bins. Further, container insertion device, bin insertion device and insertion device may be used interchangeably.

FIG. 6 is a perspective view of an automated storage and retrieval system 1. The framework structure of the automated storage and retrieval system is enclosed by walls 111. While FIG. 6 depicts a wall 111, it should be understood that an automated storage and retrieval system may comprise a framework structure that is not enclosed by a wall. According to one aspect of the invention, an opening 501 is formed in the wall 111, in order to expose a storage column 105. Obviously an opening 501 is not required if no wall surrounds the framework. Opening 501 provides lateral access to the storage column 105 of the framework structure adjacent to the wall, preferably at or near the lowermost level of the storage column 105. FIG. 6 illustrates a single opening 501, however it should be understood that according to the invention a plurality of openings 501 may be provided. The storage column 105 exposed by opening 501 is preferably devoid of containers. Opening 501 may be a simple opening as depicted or may be have a door or panel that may be selectively opened or closed.

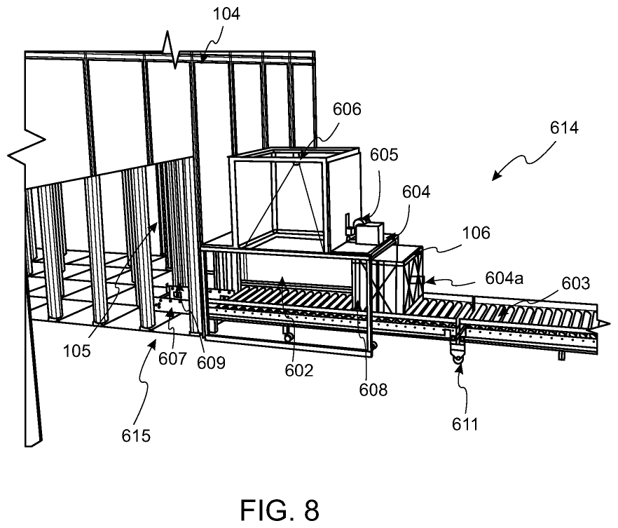

FIG. 7 depicts an embodiment of a container insertion device 600 of the invention positioned adjacent to (and concealing) the opening 501 in the wall 111 from FIG. 6. According to one aspect, container insertion device 600 is a portable device. According to one aspect container insertion device 600 comprises wheels 611, allowing the container insertion device to be rolled along a floor 613 of a facility in which the automated storage and retrieval system is installed to the opening 501.

Container insertion device 600 comprises a conveyor 603 arranged to transport containers 106 to be inserted into the storage and retrieval system from a rear part 614 of the insertion device to a forward part 615 of the insertion device. In one embodiment the device comprises a compartment 601 having a through-going passage 602. Throughgoing passage 602 has an entrance 608 and an exit 609. The conveyor 603 in this embodiment is arranged for transporting storage containers 106 longitudinally through passage 602. Conveyor 603 is preferably an automated conveyor belt, controlled by control system 500 of the automated storage and retrieval system.

Container insertion device 600 further comprises one or more container-preparation devices for automatically performing functions required to prepare a container for insertion into the storage and retrieval system. Examples of such container-preparation devices include a labelling device 604 arranged to automatically affix a label 604a to the container. The label, which may comprise a QR code or other machine readable code, comprises identification information for the container. In one aspect, the labelling device 604 automatically transmits the information regarding the label to the control system 500 of the storage and retrieval system. In addition, or alternatively, the insertion device 600 may comprise an ID scanner 605 arranged to scan a label 604a and transmit the identification information for the container to control system 500. Such an ID scanner may scan the label 604a affixed by labeling device 604, or could be used in the situation where containers have pre-affixed identification labels. The container-preparation devices may further include a dimension scanning device 606, such as a camera, laser scanner or other such device for measuring the dimensions of the container. Scanning device 606 is used to measure the physical dimensions of the container in order to confirm that the size of the container is within predefined tolerances prior to insertion. In one embodiment, the container-preparation devices are mounted in or on compartment 601 as illustrated, however it should be understood that such devices could be supported above or to the sides of the conveyor 603 by other means.

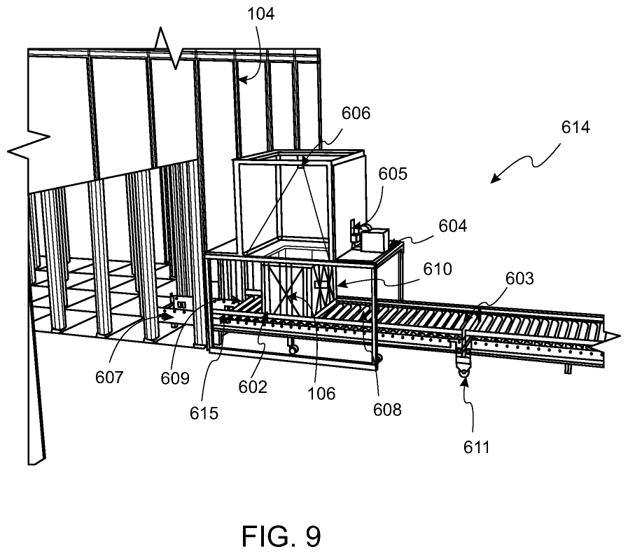

As shown in FIGS. 8-11, container insertion device 600 further comprises an exit platform or support 607 protruding longitudinally beyond the forward part 615 of the device, for example beyond exit 609 in the embodiment comprising compartment 601. Platform 607 is dimensioned to be inserted into storage column 105 and to provide a resting place/support for containers 106 exiting the forward part 615 of the device/compartment 601 and awaiting retrieval by a container handling vehicle of the system. Platform or support 607 is illustrated as a platform having a flat surface, however one skilled in the art would understand that the term platform in this context would encompass other structures that perform the same function, such as support rails and the like.

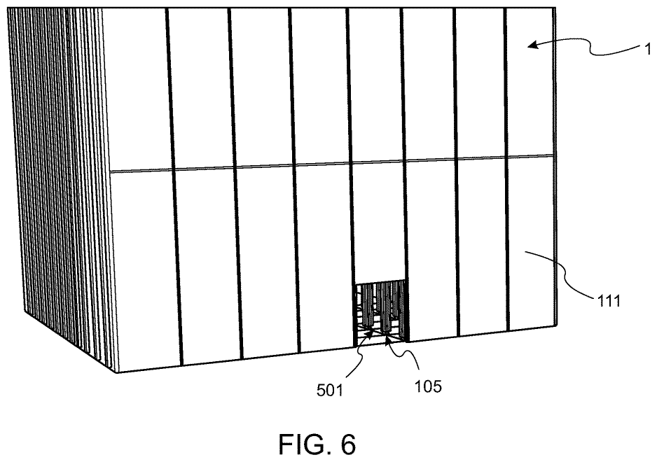

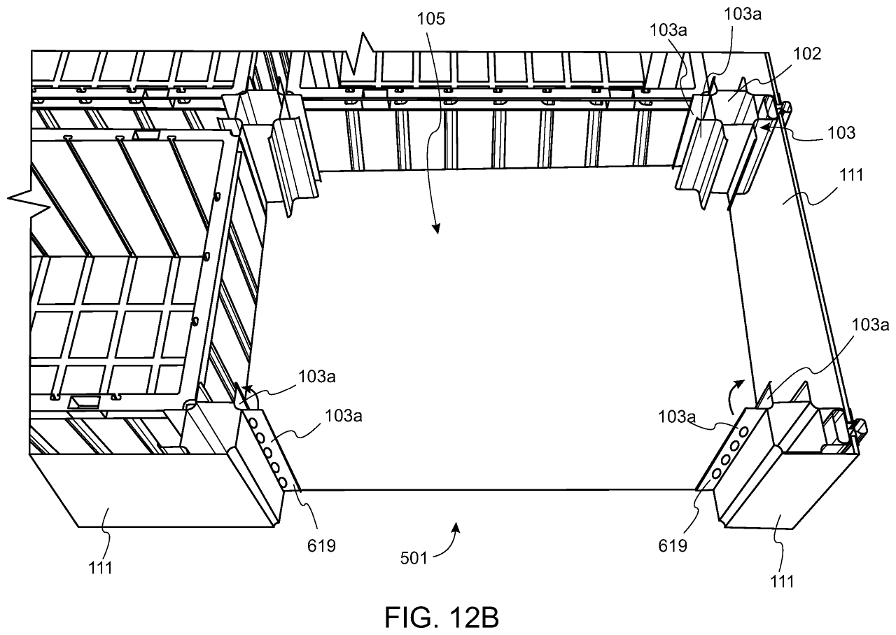

As shown in FIG. 5, a storage column in an automated storage and retrieval system is typically defined by four upright members comprising corner guide profiles 103. Such guide profiles retain the storage containers with the confines of the storage column, but would thereby prevent lateral insertion of the exit platform 607 of the insertion device and/or the lateral insertion of storage containers by the device. Consequently, according to an aspect of the invention, a lateral opening 617 is formed in the guide profiles to permit such lateral insertion. In one embodiment shown in FIG. 12A, lateral opining 617 in the guide profile comprises removing a segment of guide profile faces 103a on the guide profiles located between opening 501 and storage column 105. In an embodiment shown in FIG. 12B, lateral opening 617 in the guide profile comprises a hinged segment 619 in guide profile faces 103a. Hinged segments are arranged to be pushed aside by platform 607 and/or containers 106, thus permitting lateral access to the storage column. In one aspect, hinged segment 619 may be spring loaded, such that it snaps back into place when platform 607 is removed.

Referring to FIGS. 6-12, the sequence of steps in a method of inserting a container into a storage and retrieval system using the device of the invention will be explained.

First, an opening 501 is provided in a wall 111 surrounding the framework of an automated storage and retrieval system, in the event there is such a wall, exposing a storage column 105.

Storage column 105 is modified to permit the lateral insertion of storage containers, by providing a lateral opening 617 as shown in FIGS. 12A and/or 12B.

A container insertion device 600 as described above is transported to opening 501, for example by being wheeled along the floor of the facility and placed adjacent the opening, with the exit platform 607 of the device being inserted into the exposed storage column 105.

As shown in FIG. 7, a storage container 106 that is to be inserted into the storage column 106 of the automated storage and retrieval system is placed on the conveyor 603 towards the rear part 614 of the container insertion device. The storage container 106 is then transported by the conveyor 603 towards the container preparation devices. In an aspect, the conveyor 603 is configured to transport several storage containers 106 one after another.

FIG. 8 illustrates the preparation of a storage container to be inserted into the storage column 106 of the automated storage and retrieval system. In the example embodiment shown here, the storage container 106 passes through a compartment 602 that comprises container preparation devices. However, instead of a compartment 602 the container preparation device may also be mounted on a support as described above.

The container preparation devices thereupon perform various automatic tasks in order to prepare the container for insertion into the storage and retrieval system. For example, a labelling device 604 may affix an identification tag or a label 604a to the storage container 106 as shown in FIG. 8. The identification tag may also be a barcode, QR code, engraving or other forms of machine readable information.

Identifying information for the container is transmitted to the control system 500 of the storage and retrieval system. Such information may be transmitted by the label affixing device 604, or by a scanning device 605 may scan the label and transmit the identification information. Scanning device 605 would perform the same function in the event the containers are prelabeled.

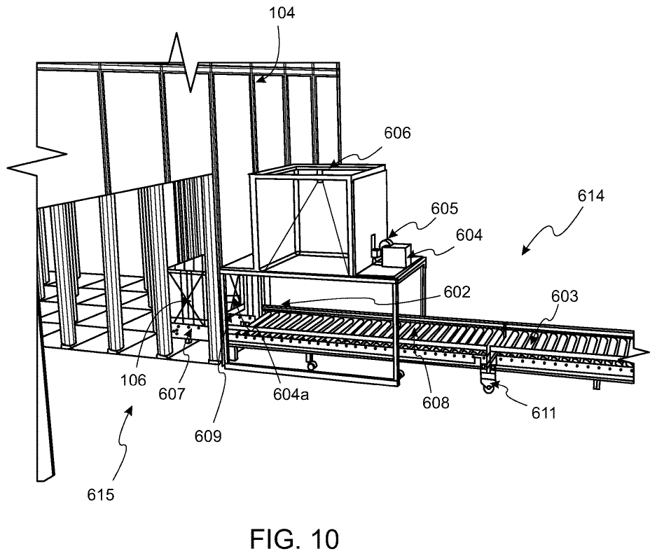

FIG. 9 illustrates the storage container being checked for dimensions and scanned by a dimension scanning device 606 before insertion into the storage column of the automated storage and retrieval system. Dimension scanning device 606 may be a cameral or other type of scanner such as a laser scanning device. The measured dimension are compared to predefined tolerances. If the dimensions are within acceptable tolerances, the containers is cleared for insertion, if the dimensions are outside the tolerances, the container is rejected from insertion, and for example a warning lamp or other signal may indicate the need to remove the container from the device. Camera 606 may also record an image of the container for various archival or other purposes.

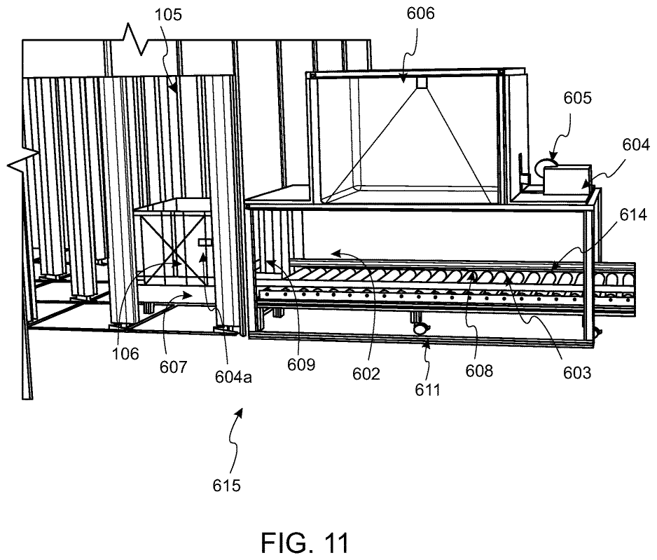

FIG. 10 depicts a storage container exiting the container-preparation area and towards the exit platform 607 inside the storage column. In one aspect, the dimensions of the platform 607 are essentially same as or less than the size of a grid cell occupying the storage column, the platforming having pushed aside hinged segments 619 from FIG. 12B, or other having passed through lateral opening 617.

As shown in FIG. 10, a storage container 106 that has been cleared for insertion arrives on the platform 607 and rests within the storage column 105 waiting to be picked up by a container handling vehicle that is instructed by the control unit 500 to pickup of the storage container 106.

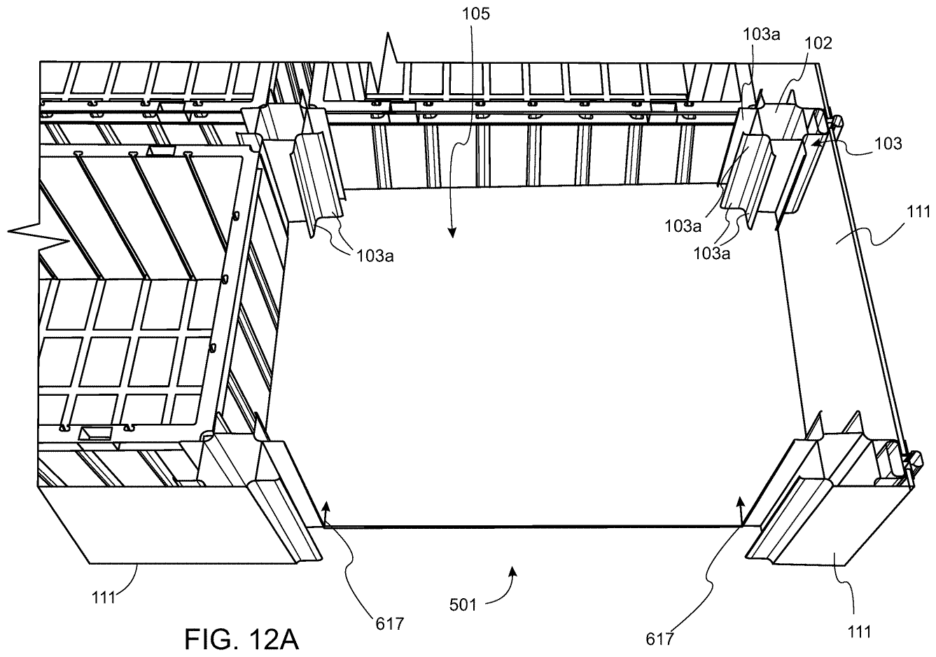

FIG. 11 shows a close up view of the storage column 105, with the storage container resting on the platform of the container insertion device 600 awaiting to be picked up by a container handling vehicle 201, 301, 401 of the storage system by means of its gripping and lifting devices.

Furthermore, the sequence of steps described above are repeated for each storage container 106 that is inserted into the automated storage and retrieval system 1. Once all the storage containers 106 are inserted into the system, the control system may be sent or send instructions of completion of the container insertion process. The container insertion device 600 may then be removed from the storage column 105. The storage column 105 then may be used as an ordinary storage column 105 to store storage containers 106.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

LIST OF REFERENCE NUMBERS
Prior art (FIGS. 1-4):

| | |
|---|---|
| 1 | Prior art automated storage and retrieval system |
| 100 | Framework structure |
| 102 | Upright members of framework structure |
| 104 | Storage grid |
| 103 | Guide profile |
| 103a | Guide profile face |
| 105 | Storage column |
| 106 | Storage container |
| 106' | Particular position of storage container |
| 107 | Stack |
| 108 | Rail system |
| 110 | Parallel rails in first direction (X) |
| 111 | Wall |
| 112 | Access opening |
| 119 | First port column |
| 120 | Second port column |
| 201 | Prior art container handling vehicle |
| 201a | Vehicle body of the container handling vehicle 201 |
| 201b | Drive means/wheel arrangement/first set of wheels |
| | in first direction (X) |
| 201c | Drive means/wheel arrangement/second set of wheels |
| | in second direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 304 | Gripping device |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 500 | Control system |
| X | First direction |
| Y | Second direction |
| Z | Third direction |
| 600 | Bin/storage container insertion device |
| 601 | Compartment |
| 602 | Passage/storage container handling area |
| 603 | Conveyors |
| 604 | Labelling device |
| 604a | Label |
| 605 | ID Scanner |
| 606 | Dimension scanning deive |
| 607 | Platform |
| 608 | Entry |
| 609 | exit |
| 610 | ID tag |
| 611 | Wheels |
| 613 | Floor |
| 614 | Rear part |
| 615 | Forward part |
| 617 | Lateral opening in guide profile |
| 619 | Hinged segment |

1-18. (canceled)

19. A container insertion device for inserting storage containers into an automated storage and retrieval system laterally through a storage column of the system, the device comprising:
a conveyor arranged for transporting the storage containers from a rear part of the container insertion device to a forward part of the container insertion device;
an exit platform or support extending from the forward part of the container insertion device, the platform or support being arranged to receive and support the storage containers to be inserted into the storage and retrieval system, wherein the platform or support is dimensioned to be laterally inserted into the storage column and thereby support a storage container of the storage containers within the storage column for retrieval by a container-handling vehicle of the system; and
one or more of a label affixing device for affixing an identification label to a storage container of the storage containers, an ID scanning device for scanning an identification label, and/or a dimension scanning device arranged to measure physical dimensions of a storage container of the storage containers, the one or more of said devices being in electronic communication with a control system of the storage and retrieval system.

20. The device in accordance with claim 19, wherein the container insertion device further comprises a compartment that has a through-going passage for the storage containers with an entrance and an exit, wherein the compartment comprises the at least one of the said label affixing device, the ID scanning device, and/or the dimension scanning device.

21. The device in accordance with claim 19, wherein the platform or support of the device is arranged to be inserted through a lateral opening in the storage column, the lateral opening dimensioned to permit lateral insertion of the storage container.

22. The device in accordance with claim 19, wherein the device further comprises a set of wheels mounted on an underside of the device.

23. The device in accordance with claim 19, wherein the identification label is at least one of a barcode, a QR code, an engraving on the storage container, or any machine readable code that is readable by a scanner.

24. The device in accordance with claim 19, wherein the dimension scanning device is a camera or a laser scanning device.

25. The device in accordance with claim 19, wherein the platform or support has essentially the same lateral dimensions as the storage container.

26. The device in accordance with claim 19, wherein the platform or support is configured to slide laterally into the storage column by pressing aside movable segments of corner guide profiles arranged on upright members defining the storage column.

27. An automated storage and retrieval system comprising a framework structure forming a storage grid, the automated storage and retrieval system comprising:
an exposed storage column at a periphery of the framework structure, the exposed storage column having a lateral opening permitting lateral insertion of storage containers into the exposed storage column; and
a device according to claim 19 arranged for inserting storage containers through the lateral opening for subsequent retrieval by container handling vehicles.

28. The automated storage and retrieval system as in claim 27, the framework structure comprising:
a rail system arranged at an upper level of the framework structure, the rail system comprising a first set of parallel rails arranged in a horizontal plane and extending in a first direction, and a second set of parallel rails arranged in the horizontal plane and extending in a second direction which is orthogonal to the first direction, the first and second sets of rails forming a grid pattern in the horizontal plane comprising a plurality of adjacent grid cells, and the storage grid defining a plurality of columns for use as storage columns, each storage column being arranged to store a respective stack of storage containers, wherein the storage columns are located beneath the rail system and wherein each storage column is located vertically below a respective grid cell;
a plurality of container handling vehicles configured to operate on the rail system for storing the storage containers in and retrieving the storage containers from the storage columns; and
a control system configured for sending instructions to the plurality of container handling vehicles.

29. The automated storage and retrieval system as in claim 27, wherein the exposed storage column is exposed due to there being an opening in a wall enclosing the framework structure.

30. The automated storage and retrieval system as in claim 27, wherein the lateral opening comprises removed segments of faces of corner guide profiles affixed to upright members defining the exposed storage column.

31. The automated storage and retrieval system as in claim 27, wherein the lateral opening comprises hinged segments of faces of corner guide profiles affixed to upright members defining the exposed storage column.

32. A method for inserting storage containers into an automated storage and retrieval system, the method comprising the steps of:
exposing a storage column at a periphery of a framework structure of the automated storage and retrieval system;
providing a lateral opening in the storage column, the lateral opening dimensioned to permit lateral insertion of storage containers into the storage column;
providing a container insertion device according to claim 19;
inserting the platform or support of the container insertion device through the lateral opening in the storage column such that the platform or support extends into the storage column;
placing the storage containers, one after the other, on the conveyor at the rear part of container insertion device;
activating the conveyor and transporting the storage containers in sequence downstream through the container insertion device; and
at least one of:
affixing an identification label to a storage container of the storage containers;
communicating identification information contained in an identification label to the control system; or
measuring physical dimensions of a storage container of the storage containers using a dimension scanning device.

33. The method according to claim 32 comprising:
transporting the storage containers along the conveyor until a storage container of the storage containers rests upon the platform or support within the storage column;
sending instructions to a container handling vehicle of the automated storage and retrieval system to pick up the storage container from the platform or support; and
transporting subsequent containers of the storage containers in sequence to the platform or support for retrieval by container handling vehicles.

34. The method according to claim 32, wherein the identification label is a barcode, a QR code, or an engraving on the storage container.

35. The method according to claim 32, wherein the identification label is automatically affixed by a labeling device.

36. The method according to claim 32, wherein the step of providing the lateral opening in the storage column comprises a step of removing a segment of a face of a corner guide profile affixed to upright members defining the storage column.

37. The method according to claim 32, wherein the step of providing the lateral opening in the storage column comprises a step of arranging a movable segment of a face of a corner guide profile affixed to upright members defining the storage column.

38. The method according to claim 32, wherein the step of measuring the physical dimensions of the storage container includes comparing the physical dimensions to predefined measurement tolerances.
